(19) United States
(12) Patent Application Publication
(10) Pub. No.: US 2024/0140412 A1
(43) Pub. Date: May 2, 2024

(54) CONTROLLING A VEHICLE WITH RESPECT TO A CYCLIST

(71) Applicant: Volvo Car Corporation, Göteborg (SE)

(72) Inventors: Oswaldo PEREZ BARRERA, Göteborg (SE); Anders LENNARTSSON, Göteborg (SE)

(21) Appl. No.: 18/490,314

(22) Filed: Oct. 19, 2023

(30) Foreign Application Priority Data
Oct. 28, 2022 (EP) 22204520.5

(51) Int. Cl. B60W 30/09; B60W 30/095; B60W 30/14; B60W 40/105; G06V 20/58; G06V 40/10

(52) U.S. Cl. CPC B60W 30/09; B60W 30/0956; B60W 30/146; B60W 40/105; G06V 20/58; G06V 40/10; B60W 2420/42; B60W 2554/4026; B60W 2554/4041; B60W 2554/4045; B60W 2554/80; B60W 2556/40

(57) ABSTRACT

The disclosure relates to a method for controlling a vehicle. The vehicle shares a traffic infrastructure with a cyclist. The method comprises detecting the cyclist and a location of the cyclist. Subsequently, based on a body pose of the cyclist and a map information, a cyclist path is estimated along which the cyclist is expected to be travelling. Moreover, the method comprises determining whether the vehicle path and the cyclist path interfere with one another. A location of interference of the vehicle path and the cyclist path is determined respectively if the vehicle path and the cyclist path interfere with one another. Additionally, an interference risk describing whether the vehicle and the cyclist risk to interfere with one another at the location of interference is determined and a reaction maneuver is triggered.

### CROSS-REFERENCE TO RELATED APPLICATIONS

This application claims the benefit of and priority to pending EP patent application serial number 22204520.5, filed Oct. 28, 2022, and entitled “METHOD FOR CONTROLLING A VEHICLE, DATA PROCESSING APPARATUS, VEHICLE, COMPUTER PROGRAM, AND COMPUTER-READABLE STORAGE MEDIUM,” the entirety of which is hereby incorporated by reference herein.

### TECHNICAL FIELD

The disclosed subject matter relates to vehicles (e.g., transportation vehicles) and, more particularly, to control of a vehicle with respect to a cyclist.

### BACKGROUND

When vehicles and cyclists share traffic infrastructure, accidents between vehicles and cyclists are to be avoided. This is especially the case since cyclists are much more vulnerable as compared to vehicles. In a case in which the vehicle is operated by a human driver, it is the human driver's responsibility to see the cyclist and maneuver the vehicle such that no accident occurs. In a case in which the vehicle is a fully or partly autonomous vehicle, a computer-implemented method for controlling the vehicle has the task to avoid accidents.

The above-described background relating to vehicle control is merely intended to provide a contextual overview of some current issues and is not intended to be exhaustive. Other contextual information may become further apparent upon review of the following detailed description.

### SUMMARY

The following presents a summary to provide a basic understanding of one or more embodiments of the invention. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, systems, devices, computer-implemented methods, apparatuses and/or computer program products that facilitate controlling a vehicle (e.g., with respect to a cyclist) are described.

As alluded to above, vehicles or corresponding vehicle systems can be improved in various ways, and various embodiments are described herein to this end and/or other ends.

According to an embodiment, a method for controlling a vehicle, wherein the vehicle is travelling along a known vehicle path and shares a traffic infrastructure with a cyclist, can comprise detecting, by a system comprising a processor, the cyclist based on at least one image received via the vehicle, determining, by the system, a location of the cyclist, estimating, by the system, a cyclist path along which the cyclist is expected to be travelling based on a body pose of the cyclist and a map information describing at least a part of the traffic infrastructure, determining, by the system, whether the vehicle path and the cyclist path interfere with one another and determining a location of interference of the vehicle path and the cyclist path respectively if the vehicle path and the cyclist path interfere with one another, determining, by the system, an interference risk describing whether the vehicle and the cyclist risk to interfere with one another at the respective location of interference, if the vehicle path and the cyclist path interfere with one another, and triggering, by the system, a reaction maneuver of the vehicle if an interference risk is determined.

According to another embodiment, a non-transitory machine-readable medium can comprise executable instructions that, when executed by a processor, facilitate performance of operations, comprising detecting a cyclist based on at least one image captured via a vehicle travelling along a known vehicle path and sharing a traffic infrastructure with the cyclist, determining a location of the cyclist, estimating a cyclist path along which the cyclist is expected to be travelling based on a body pose of the cyclist and a map information describing at least a part of the traffic infrastructure, determining whether the vehicle path and the cyclist path interfere with one another and determining a location of interference of the vehicle path and the cyclist path respectively if the vehicle path and the cyclist path interfere with one another, determining an interference risk describing whether the vehicle and the cyclist risk to interfere with one another at the respective location of interference, if the vehicle path and the cyclist path interfere with one another, and triggering a reaction maneuver of the vehicle if an interference risk is determined.

According to yet another embodiment, a system can comprise a memory that stores computer executable components, and a processor that executes the computer executable components stored in the memory, wherein the computer executable components comprise a detection component that detects a cyclist based on at least one image received from an environment detection component of a vehicle travelling along a known vehicle path and sharing a traffic infrastructure with the cyclist, a location component that determines a location of the cyclist, an estimation component that estimates a cyclist path along which the cyclist is expected to be travelling based on a body pose of the cyclist and a map information describing at least a part of the traffic infrastructure, an interference component that determines whether the vehicle path and the cyclist path interfere with one another and determining a location of interference of the vehicle path and the cyclist path respectively if the vehicle path and the cyclist path interfere with one another, a risk component that determines an interference risk describing whether the vehicle and the cyclist risk to interfere with one another at the respective location of interference, if the vehicle path and the cyclist path interfere with one another, and a reaction maneuver component that triggers a reaction maneuver of the vehicle if an interference risk is determined.

### BRIEF DESCRIPTION OF DRAWINGS

FIG. 1 illustrates a block diagram of an exemplary system in accordance with one or more embodiments described herein.

FIG. 2 illustrates a block diagram of example, non-limiting computer executable components in accordance with one or more embodiments described herein.

FIG. 3 illustrates an example, non-limiting scenario in accordance with one or more embodiments described herein.

FIG. 4 illustrates an example, non-limiting scenario in accordance with one or more embodiments described herein.

FIG. 5 illustrates an example, non-limiting scenario in accordance with one or more embodiments described herein.

FIG. 6 illustrates an example, non-limiting scenario in accordance with one or more embodiments described herein.

FIG. 7 illustrates an example, non-limiting scenario in accordance with one or more embodiments described herein.

FIG. 8 illustrates a block flow diagram for a process associated with controlling a vehicle in accordance with one or more embodiments described herein.

FIG. 9 is an example, non-limiting computing environment in which one or more embodiments described herein can be implemented.

FIG. 10 is an example, non-limiting networking environment in which one or more embodiments described herein can be implemented.

### DETAILED DESCRIPTION

The following detailed description is merely illustrative and is not intended to limit embodiments and/or application or uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

It will be understood that when an element is referred to as being “coupled” to another element, it can describe one or more different types of coupling including, but not limited to, chemical coupling, communicative coupling, capacitive coupling, electrical coupling, electromagnetic coupling, inductive coupling, operative coupling, conductive coupling, acoustic coupling, ultrasound coupling, optical coupling, physical coupling, thermal coupling, and/or another type of coupling. As referenced herein, an “entity” can comprise a human, a client, a user, a computing device, a software application, an agent, a machine learning model, an artificial intelligence, and/or another entity. It should be appreciated that such an entity can facilitate implementation of the subject disclosure in accordance with one or more embodiments the described herein.

The computer processing systems, computer-implemented methods, apparatus and/or computer program products described herein employ hardware and/or software to solve problems that are highly technical in nature (e.g., controlling a vehicle), that are not abstract and cannot be performed as a set of mental acts by a human.

The present disclosure relates to a method for controlling a vehicle. The vehicle can be travelling along a known vehicle path and can share a traffic infrastructure with a cyclist. In the present context, the traffic infrastructure is to be understood as the network of roads and pathways on which the vehicle and the cyclist can travel. The cyclist is to be understood as the combination of a bicycle and a human riding the bicycle. It is an objective of the present disclosure to enable control of a vehicle, especially a fully or partly autonomous vehicle. This enables the vehicle and the cyclist to share the traffic infrastructure in a safe manner.

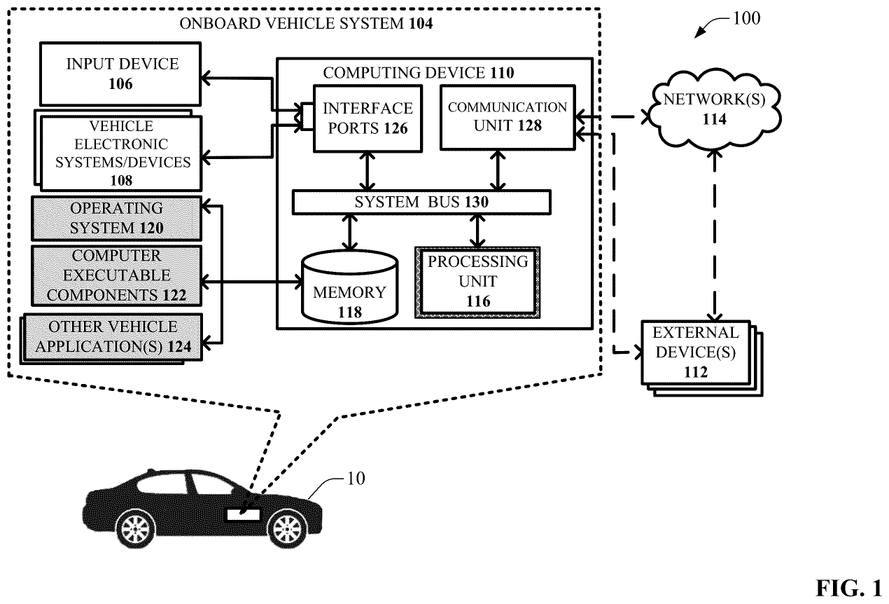

Turning now to FIG. 1, there is illustrated an example, non-limiting system 100 in accordance with one or more embodiments herein. System 100 can comprise a computerized tool, which can be configured to perform various operations relating to vehicle control. In accordance with various exemplary embodiments, system 100 can be deployed on or within a vehicle 10, (e.g., an automobile, as shown in FIG. 1). Although FIG. 1 depicts the vehicle 10 as an automobile, the architecture of the system 100 is not so limited. For instance, the system 100 described herein can be implemented with a variety of types of vehicles 10. Example vehicles 10 that can incorporate the exemplary system 100 can include, but are not limited to: automobiles (e.g., autonomous vehicles or semi-autonomous vehicles), airplanes, trains, motorcycles, carts, trucks, semi-trucks, buses, boats, recreational vehicles, helicopters, jets, electric scooters, electric bicycles, a combination thereof, and/or the like. It is additionally noted that the system 100 can be implemented in a variety of types of automobiles, such as battery electric vehicles, hybrid vehicles, plug-in hybrid vehicles, internal combustion engine vehicles, or other suitable types of vehicles.

As shown in FIG. 1, the system 100 can comprise one or more onboard vehicle systems 104, which can comprise one or more input devices 106, one or more other vehicle electronic systems and/or devices 108, and/or one or more computing devices 110. Additionally, the system 100 can comprise one or more external devices 112 that can be communicatively and/or operatively coupled to the one or more computing devices 110 of the one or more onboard vehicle systems 104 either via one or more networks 114 and/or a direct electrical connection (e.g., as shown in FIG. 1). In various embodiments, one or more of the onboard vehicle system 104, input devices 106, vehicle electronic systems and/or devices 108, computing devices 110, external devices 112, and/or networks 114 can be communicatively or operably coupled (e.g., over a bus or wireless network) to one another to perform one or more functions of the system 100.

The one or more input devices 106 can display one or more interactive graphic entity interfaces (“GUIs”) that facilitate accessing and/or controlling various functions and/or application of the vehicle 10. The one or more input devices 106 can display one or more interactive GUIs that facilitate accessing and/or controlling various functions and/or applications. The one or more input devices 106 can comprise one or more computerized devices, which can include, but are not limited to: personal computers, desktop computers, laptop computers, cellular telephones (e.g., smartphones or mobile devices), computerized tablets (e.g., comprising a processor), smart watches, keyboards, touchscreens, mice, a combination thereof, and/or the like. An entity or user of the system 100 can utilize the one or more input devices 106 to input data into the system 100. Additionally, the one or more input devices 106 can comprise one or more displays that can present one or more outputs generated by the system 100 to an entity. For example, the one or more displays can include, but are not limited to: cathode tube display (“CRT”), light-emitting diode display (“LED”), electroluminescent display (“ELD”), plasma display panel (“PDP”), liquid crystal display (“LCD”), organic light-emitting diode display (“OLED”), a combination thereof, and/or the like.

For example, the one or more input devices 106 can comprise a touchscreen that can present one or more graphical touch controls that can respectively correspond to a control for a function of the vehicle 10, an application, a function of the application, interactive data, a hyperlink to data, and the like, wherein selection and/or interaction with the graphical touch control via touch activates the corresponding functionality. For instance, one or more GUIs displayed on the one or more input devices 106 can include selectable graphical elements, such as buttons or bars corresponding to a vehicle navigation application, a media application, a phone application, a back-up camera function, a car settings function, a parking assist function, and/or the like. In some implementations, selection of a button or bar corresponding to an application or function can result in the generation of a new window or GUI comprising additional selectable icons or widgets associated with the selected application. For example, selection of one or more selectable options herein can result in generation of a new GUI or window that includes additional buttons or widgets with one or more selectable options. The type and appearance of the controls can vary. For example, the graphical touch controls can include icons, symbols, widgets, windows, tabs, text, images, a combination thereof, and/or the like.

The one or more input devices 106 can comprise suitable hardware that registers input events in response to touch (e.g., by a finger, stylus, gloved hand, pen, etc.). In some implementations, the one or more input devices 106 can detect the position of an object (e.g., by a finger, stylus, gloved hand, pen, etc.) over the one or more input devices 106 within close proximity (e.g., a few centimeters) to touchscreen without the object touching the screen. As used herein, unless otherwise specified, reference to “on the touchscreen” refers to contact between an object (e.g., an entity's finger) and the one or more input devices 106 while reference to “over the touchscreen” refers to positioning of an object within close proximity to the touchscreen (e.g., a defined distance away from the touchscreen) yet not contacting the touchscreen.

The type of the input devices 106 can vary and can include, but is not limited to: a resistive touchscreen, a surface capacitive touchscreen, a projected capacitive touchscreen, a surface acoustic wave touchscreen, and an infrared touchscreen. In various embodiments, the one or more input devices 106 can be positioned on the dashboard of the vehicle 10, such as on or within the center stack or center console of the dashboard. However, the position of the one or more input devices 106 within the vehicle 10 can vary.

The one or more other vehicle electronic systems and/or devices 108 can include one or more additional devices and/or systems (e.g., in addition to the one or more input devices 106 and/or computing devices 110) of the vehicle 10 that can be controlled based at least in part on commands issued by the one or more computing devices 110 (e.g., via one or more processing units 116) and/or commands issued by the one or more external devices 112 communicatively coupled thereto. For example, the one or more other vehicle electronic systems and/or devices 108 can comprise: seat motors, seatbelt system(s), airbag system(s), display(s), infotainment system(s), speaker(s), a media system (e.g., audio and/or video), a back-up camera system, a heating, ventilation, and air conditioning (“HVAC”) system, a lighting system, a cruise control system, a power locking system, a navigation system, an autonomous driving system, a vehicle sensor system, telecommunications system, a combination thereof, and/or the like. Other example other vehicle electronic systems and/or devices 108 can comprise one or more sensors, which can comprise distance sensors, seats, seat position sensor(s), collision sensor(s), odometers, altimeters, speedometers, accelerometers, engine features and/or components, fuel meters, flow meters, cameras (e.g., digital cameras, heat cameras, infrared cameras, and/or the like), lasers, radar systems, lidar systems, microphones, vibration meters, moisture sensors, thermometers, seatbelt sensors, wheel speed sensors, a combination thereof, and/or the like. For instance, a speedometer of the vehicle 10 can detect the vehicle's 10 traveling speed. Further, the one or more sensors can detect and/or measure one or more conditions outside the vehicle 10, such as: whether the vehicle 10 is traveling through a rainy environment, whether the vehicle 10 is traveling through winter conditions (e.g., snowy and/or icy conditions), whether the vehicle 10 is traveling through very hot conditions (e.g., desert conditions), and/or the like. Example navigational information can include, but is not limited to: the destination of the vehicle 10, the position of the vehicle 10, the type of vehicle 10, the speed of the vehicle 10, environmental conditions surrounding the vehicle 10, the planned route of the vehicle 10, traffic conditions expected to be encountered by the vehicle 10, operational status of the vehicle 10, a combination thereof, and/or the like.

The one or more computing devices 110 can facilitate executing and controlling one or more operations of the vehicle 10, including one or more operations of the one or more input devices 106, and the one or more other vehicle electronic systems/devices 108 using machine-executable instructions. In this regard, embodiments of system 100 and other systems described herein can include one or more machine-executable components embodied within one or more machines (e.g., embodied in one or more computer readable storage media associated with one or more machines, such as computing device 110). Such components, when executed by the one or more machines (e.g., processors, computers, virtual machines, etc.) can cause the one or more machines to perform the operations described.

For example, the one or more computing devices 110 can include or be operatively coupled to at least one memory 118 and/or at least one processing unit 116. The one or more processing units 116 can be any of various available processors. For example, dual microprocessors and other multiprocessor architectures also can be employed as the processing unit 116. In various embodiments, the at least one memory 118 can store software instructions embodied as functions and/or applications that when executed by the at least one processing unit 116, facilitate performance of operations defined by the software instruction. In the embodiment shown, these software instructions can include one or more operating system 120, one or more computer executable components 122, and/or one or more other vehicle applications 124. For example, the one or more operating systems 120 can act to control and/or allocate resources of the one or more computing devices 110. It is to be appreciated that the claimed subject matter can be implemented with various operating systems or combinations of operating systems.

The one or more computer executable components 122 and/or the one or more other vehicle applications 124 can take advantage of the management of resources by the one or more operating systems 120 through program modules and program data also stored in the one or more memories 118. The one or more computer executable components 122 can provide various features and/or functionalities that can facilitate prevention of pedestrian accidents herein. Example, other vehicle applications 124 can include, but are not limited to: a navigation application, a media player application, a phone application, a vehicle settings application, a parking assistance application, an emergency roadside assistance application, a combination thereof, and/or the like. The features and functionalities of the one or more computer executable components 122 are discussed in greater detail infra.

The one or more computing devices 110 can further include one or more interface ports 126, one or more communication units 128, and a system bus 130 that can communicatively couple the various features of the one or more computing devices 110 (e.g., the one or more interface ports 126, the one or more communication units 128, the one or more memories 118, and/or the one or more processing units 116). The one or more interface ports 126 can connect the one or more input devices 106 (and other potential devices) and the one or more other vehicle electronic systems/devices 108 to the one or more computing devices 110. For example, the one or more interface ports 126 can include, a serial port, a parallel port, a game port, a universal serial bus (“USB”) and the like.

The one or more communication units 128 can include suitable hardware and/or software that can facilitate connecting one or more external devices 112 to the one or more computing devices 110 (e.g., via a wireless connection and/or a wired connection). For example, the one or more communication units 128 can be operatively coupled to the one or more external devices 112 via one or more networks 114. The one or more networks 114 can include wired and/or wireless networks, including but not limited to, a personal area network (“PAN”), a local area network (“LAN”), a cellular network, a wide area network (“WAN”, e.g., the Internet), and the like. For example, the one or more external devices 112 can communicate with the one or more computing devices 110 (and vice versa) using virtually any desired wired or wireless technology, including but not limited to: wireless fidelity (“Wi-Fi”), global system for mobile communications (“GSM”), universal mobile telecommunications system (“UMTS”), worldwide interoperability for microwave access (“WiMAX”), enhanced general packet radio service (enhanced “GPRS”), fifth generation (“5G”) communication system, sixth generation (“6G”) communication system, third generation partnership project (“3GPP”) long term evolution (“LTE”), third generation partnership project 2 (“3GPP2”) ultra-mobile broadband (“UMB”), high speed packet access (“HSPA”), Zigbee and other 802.XX wireless technologies and/or legacy telecommunication technologies, near field communication (“NFC”) technology, BLUETOOTH®, Session Initiation Protocol (“SIP”), ZIGBEE®, RF4CE protocol, WirelessHART protocol, 6LoWPAN (IPv6 over Low power Wireless Area Networks), Z-Wave, an ANT, an ultra-wideband (“UWB”) standard protocol, and/or other proprietary and non-proprietary communication protocols. In this regard, the one or more communication units 128 can include software, hardware, or a combination of software and hardware that is configured to facilitate wired and/or wireless communication between the one or more computing devices 110 and the one or more external devices 112. While the one or more communication units 128 are shown for illustrative clarity as a separate unit that is not stored within memory 118, it is to be appreciated that one or more (software) components of the communication unit can be stored in memory 118 and include computer executable components.

The one or more external devices 112 can include any suitable computing device comprising a display and input device (e.g., a touchscreen) that can communicate with the one or more computing devices 110 comprised within the onboard vehicle system 104 and interface with the one or more computer executable components 122 (e.g., using a suitable application program interface (“API”)). For example, the one or more external devices 112 can include, but are not limited to: a mobile phone, a smartphone, a tablet, a personal computer (“PC”), a digital assistant (“PDA”), a heads-up display (“HUD”), virtual reality (“VR”) headset, an augmented reality (“AR”) headset, or another type of wearable computing device, a desktop computer, a laptop computer, a computer tablet, a combination thereof, and the like.

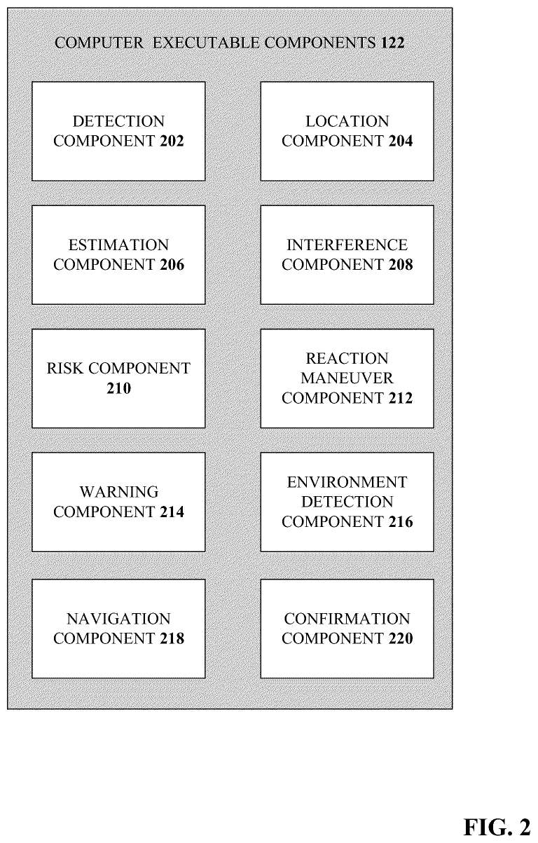

FIG. 2 illustrates a block diagram of example, non-limiting computer executable components 122 that can facilitate vehicle control in accordance with one or more embodiments described herein. Repetitive description of like elements employed in other embodiments described herein is omitted for sake of brevity. As shown in FIG. 2, the one or more computer executable components 122 can comprise detection component 202, location component 204, user estimation component 206, interference component 208, risk component 210, reaction maneuver component 212, warning component 214, environment detection component 216, navigation component 218, and/or confirmation component 220.

In various embodiments herein, a vehicle 10 can be travelling along a known vehicle path P and can share a traffic infrastructure I with a cyclist 28. In various embodiments, the vehicle 10 can comprise a fully or partially autonomous vehicle.

In various embodiments, the detection component 202 can detect the cyclist 28, for instance, based on at least one image received from an environment detection component 216 of the vehicle 10. In various embodiments, the environment detection component 216 of the vehicle 10 can comprise an optical camera, and can be configured to detect the cyclist 28. In further embodiments, the environment detection component 216 can comprise two or more camera units or other suitable sensors for environment detection facing in different directions. In this regard, computer vision can be utilized (e.g., via the detection component 202) in order to detect the cyclist 28. In various embodiments, the environment detection component 216 can capture a stream of images. The cyclist 28 is represented in the images of the stream of images. The representation of the cyclist 28 can then be recognized (e.g., via the detection component 202) within the images. Consequently, the cyclist 28 can be detected.

In various embodiments, the location component 204 can determine a location L of the cyclist 28. In this regard, the location component 204 can determine the location L of the cyclist 28 based on the detection result of the environment detection component 216. In various embodiments, the location component 204 can determine the location L of the cyclist 28 relative to a location of the vehicle 10. It is noted that the location component 204 can determine the location L of the cyclist 28, for instance, based on the images captured by the environment detection component 216. Because a position and/or orientation of the environment detection component 216 in the vehicle 10 is known, the location L of the cyclist 28 can be determined (e.g., via the location component 204) with respect to the vehicle 10, for instance, by analyzing the size and position of the representation of the cyclist 28 in the images.

In various embodiments, the estimation component 206 can estimate a cyclist path 30 along which the cyclist 28 is expected to be travelling based on a body pose of the cyclist 28 and a map information describing at least a part of the traffic infrastructure I. In various embodiments, the body pose of the cyclist can be determined (e.g., via the estimation component 206) based on the detection result of the environment detection component 216 (e.g., the at least one image). In order to detect the body pose, one or more processes can be used. For instance, a deformable part model or an extended Kalman filter process can be used (e.g., via the estimation component 206). In various embodiments, map information herein can comprise a map of the shared traffic infrastructure I. The map information can describe at least a part of the traffic infrastructure I. In various embodiments, the map information can be obtained from the navigation component 218. Stated otherwise, the map information can describe the roads and pathways that are available for being traveled by the cyclist 28. Consequently, by evaluating the body pose together with the map information, it is possible to estimate the cyclist path (e.g., a path that the cyclist is expected to be traveling within the traffic infrastructure I). In various embodiments, estimating (e.g., via the estimation component 206) the cyclist path 30 can comprise receiving the map information from a navigation component 218 of the vehicle 10. In various embodiments, the navigation component 218 can provide map information of high accuracy and up-to-dateness. Consequently, the cyclist path 30 can be estimated (e.g., via the estimation component 206) with high reliability. In various embodiments, estimating (e.g., via the estimation component 206) the cyclist path 30 can comprise detecting a body pose of the cyclist 28. In various embodiments, the body pose of a cyclist 28 can provide valuable insight regarding a direction in which the cyclist 28 intends to travel. Consequently, the cyclist path 30 can be estimated (e.g., via the estimation component 206) with high reliability. In various embodiments, the body pose can comprise an arm pose of the cyclist 28. In various embodiments, the body pose, more precisely the arm pose, can be determined (e.g., via the detection component 202) based on the images captured by the environment detection component 216. In various embodiments, representations of the arms of the cyclist 28 can be detected (e.g., via the detection component 202) in the images, which can then determine whether the cyclist 28 extends at least one arm to the left, to the right or whether no arm is extended. When combining the information relating to the body pose of the cyclist 28 and the map information, the cyclist path 30 can be determined with high reliability. Since cyclists often indicate an intention to turn by extending an arm and pointing to the intended direction of travel, the detection of an arm pose enables reliable estimation (e.g., via the estimation component 206) of the cyclist path 30. In this regard, the cyclist 28 can extend the left arm if he or she intends to turn to the left. Similarly, the cyclist 28 can extend the right arm if he or she intends to turn to the right. If none of the arms are extended, the estimation component 206 can infer that the cyclist 28 intends to travel straight ahead. In this context, an arm pose of the cyclist can be determined (e.g., via the detection component 202) using computer vision, for instance, using a Human Pose Estimation process. It is noted that, especially the combination of detecting an arm pose of the cyclist, i.e., determining whether the cyclist 28 intends to turn to the left, turn to the right or travel straight ahead, and the map information describing at least a part of the traffic infrastructure I, can lead to a highly reliable and accurate estimation of the cyclist path 30.

In various embodiments, the interference component 208 can determine whether the vehicle path P and the cyclist path 30 interfere with one another, and determine a location of interference of the vehicle path P and the cyclist path 30, respectively, if the vehicle path P and the cyclist path 30 interfere with one another. It is noted that the vehicle path P can be known or determined (e.g., via the interference component 208). Based on this information, the interference component 208 can determine whether the vehicle path P and the cyclist path 30 interfere with one another. In this regard, the interference component 208 can determine whether the vehicle path P and the cyclist path 30 cross each other or have a defined minimum distance being smaller than a defined distance threshold. Stated otherwise, the interference component 208 can determine whether the vehicle path P and the cyclist path 30 are at least partially closer to each other than the defined distance threshold, which can represent a safety distance. In an example, determining whether the vehicle path P and the cyclist path interfere 30 with one another can comprise determining (e.g., via the interference component 208) a minimal path distance 32 between the vehicle path P and the cyclist path 30, and comparing the minimal path distance 32 to a minimal path distance threshold. In various embodiments, the locations of interference of the vehicle path P and the cyclist path 30, respectively, can be located at the minimal path distance 32. It is noted that the minimal path distance 32 can be a geometric distance, i.e., a geometric length. In a case in which the vehicle path P and the cyclist path 30 cross or overlap each other, the minimal path distance 32 can be zero. Consequently, the determination (e.g., via the interference component 208) whether the vehicle path P and the cyclist path 30 interfere with one another can be performed in a simple and reliable manner.

In various embodiments, the system 100 can continue a corresponding process, for instance, if the vehicle path P and the cyclist path 30 are determined (e.g., via the interference component 208) to interfere. Otherwise, the process can stop.

In various embodiments, the risk component 210 can determine an interference risk describing whether the vehicle 10 and the cyclist 28 risk to interfere with one another at the respective location of interference if the vehicle path P and the cyclist path 30 interfere with one another. In various embodiments, determining an interference risk can comprise determining (e.g., via the risk component 210) a minimal traveler offset between the vehicle 10 and the cyclist 28 occurring while the vehicle 10 is travelling along the vehicle path P and the cyclist 28 is travelling along the cyclist path 30. Additionally, the minimal traveler offset can be compared (e.g., via the risk component 210) to an offset threshold. Stated otherwise, the risk component 210 can determine whether the vehicle 10 and the cyclist 28 are in a situation that they are closer to each other than the minimal traveler offset. Consequently, the interference risk can be determined (e.g., via the risk component 210) in a simple and reliable manner.

In various embodiments, the minimal traveler offset can comprise a time span T between the vehicle 10 travelling over the location of interference of the vehicle path P and the cyclist 28 travelling over the location of interference of the cyclist path 30, and the offset threshold can comprise a minimal time span threshold. In this context, the minimal time span threshold can also comprise a safety time. In this regard, if a defined sufficient amount of time passes between the vehicle 10 traveling over the location of interference of the vehicle path P and the cyclist 28 traveling over the location of interference of the cyclist path 30, no risk of interference is determined (e.g., via the risk component 210). In the opposite case, i.e., if the time span T is inferior to the minimal time span threshold, the vehicle 10 and the cyclist 28 can be traveling over the respective location of interference with a very short time distance. In this case, a risk of interference is present. From the perspective of the vehicle 10, the time span T between the vehicle 10 traveling over the location of interference of the vehicle path P and the cyclist 28 traveling over the location of interference of the cyclist path 30 can be described as a time to cross or time to pass. If the cyclist 28 has a sufficient time to pass, no risk of interference is determined (e.g., via the risk component 210). This is a reliable and computationally efficient manner for determining the interference risk. In various embodiments, the determination (e.g., via the risk component 210) can be based on a set of images provided by the environment detection component 216 of the vehicle 10.

In various embodiments, the minimal traveler offset can comprise a minimal geometric distance between the vehicle 10 and the cyclist 28, and the offset threshold can comprise a minimal traveler distance threshold. In further embodiments the minimal traveler distance threshold can also comprise a safety distance. Thus, a risk of interference can be present if the minimal geometric distance between the vehicle 10 and the cyclist 28, which are traveling along the vehicle path P and the cyclist path 30, respectively, is inferior to the minimal traveler distance threshold, i.e., the safety distance. This can be a reliable and computationally efficient manner for determining (e.g., via the risk component 210) the interference risk. In various embodiments, the determination (e.g., via the risk component 210) can be based on the at least one image provided by the environment detection component 216 of the vehicle 10.

In various embodiments, determining (e.g., via the risk component 210) an interference risk can comprise determining or receiving an information representative of at least one of:
a current cyclist speed,
a current vehicle speed,
a current distance between the vehicle and the cyclist,
a current distance between the vehicle and the location of interference of the vehicle path,
a current distance between the cyclist and the location of interference of the cyclist path,
a current time estimate describing a time needed by the vehicle to reach the location of interference of the vehicle path, and/or
a current time estimate describing at time needed by the cyclist to reach the location of interference of the cyclist path.

In various embodiments, all of the above indicators can be determined (e.g., via the system 100), for instance, based on a set of images provided by the environment detection unit of the vehicle. Consequently, the interference risk can be determined in a reliable and computationally efficient manner. This can especially be the case for the above-mentioned minimal geometric distance between the vehicle and the cyclist and the above-mentioned time span T. In order to calculate this time span T, based on the above indicators, a first time can be calculated which is needed by the vehicle to reach the location of interference of the vehicle path. Additionally, a second time can be calculated which is needed by the cyclist to reach the location of interference of the cyclist path. Thereafter, a time difference can be calculated.

It is noted that an interference of the vehicle 10 and the cyclist 28 can be different from an interference of the vehicle path P and the cyclist path 30. In an example, the vehicle path P and the cyclist path 30 can cross each other or have portions which are arranged very close to each other. Thus, the vehicle path P and the cyclist path 30 can interfere with one another. However, if the vehicle 10 travels along the vehicle path P long before the cyclist 28 travels along the cyclist path 30, the vehicle 10 and the cyclist 28 do not risk interfering with one another. Also, in the context of the evaluation of an interference risk, the process can be continued if an interference risk is determined to be present. Otherwise, the process can be abandoned. Altogether, a risk of interference between the vehicle 10 and the cyclist 28 can be determined (e.g., via the risk component 210) with high reliability.

In various embodiments, an appropriate reaction maneuver of the vehicle can be triggered (e.g., via the reaction maneuver component 212) such that accidents or undesired interferences can be avoided. In this regard, the reaction maneuver component 212 can trigger a reaction maneuver of the vehicle 10 if an interference risk is determined. In this regard, triggering (e.g., via the reaction maneuver component 212) the reaction maneuver can comprise triggering a decelerating activity of the vehicle 10 and/or triggering a steering activity of the vehicle 10. In this regard, in a case in which an interference risk (e.g., via the risk component 210) has been determined, the vehicle 10 can slow down (e.g., as facilitated via the reaction maneuver component 212). In this context, the vehicle 10 can reduce its speed (e.g., via the navigation component 218), but remain moving, or slow down until it stops. The steering activity can, for example, be triggered (e.g., via the via the reaction maneuver component 212) as a part of an evasive maneuver which has the objective of avoiding interference with the cyclist 28. In various embodiments, the triggered reaction maneuvers can be temporary until the cyclist 28 is not detected (e.g., via the detection component 202) anymore, or until the vehicle path P and the cyclist path 30 do not interfere anymore. Consequently, an interference between the vehicle and the cyclist can be reliably avoided. In various embodiments, the navigation component 218 can control a motion of the vehicle 10 along a path. It is noted that the foregoing can be performed whether or not the cyclist 28 is approaching the vehicle 10 or is traveling in the same direction as the vehicle 10.

In various embodiments, the detection component 202 can detect a face of the cyclist 28. In this regard, the reaction maneuver component 212 can adapt the triggered reaction maneuver, for instance, if the face of the cyclist 28 has been detected (e.g., via the detection component 202). From the detection of the face of the cyclist, a system 100 herein can infer that the cyclist 28 has seen the vehicle 10. Consequently, the cyclist 28 is not expected to be surprised by the presence of the vehicle 10. The triggered reaction maneuver can, for instance, be adapted (e.g., via the reaction maneuver component 212) the vehicle 10 can be permitted to come closer to the cyclist 28. Moreover, in a case in which the face of the cyclist has been detected (e.g., via the detection component 202), the minimal traveler distance threshold and/or the minimal time span threshold can be reduced as compared to a situation in which the face of the cyclist 28 has not been detected (e.g., via the detection component 202).

In various embodiments, the warning component 214 can trigger a warning activity of the vehicle 10. In various embodiments, the warning activity can comprise a visual and/or acoustic warning. For example, the vehicle 10 can be caused (e.g., via the warning component 214) to honk or turn on corresponding hazard lights. Consequently, the vehicle 10 is enabled to draw the attention of the cyclist 28 to the interference risk. The foregoing further improves safety. In various embodiments, the warning activity can be selected (e.g., via the warning component 214) based on the minimal geometric distance between the vehicle 10 and the cyclist 28 and/or the time span between the vehicle 10 travelling over the location of interference of the vehicle path P and the cyclist 28 travelling over the location of interference of the cyclist path 30, as previously discussed. The foregoing enables appropriate warning activities.

In various embodiments, the confirmation component 220 can trigger a confirmation activity of the vehicle 10, for instance, if the cyclist 28 has been detected (e.g., via the detection component 202). Consequently, the cyclist 28 can be in a position to know that the vehicle 10, especially an autonomous vehicle, has detected the cyclist 28. An example of a confirmation activity can comprise blinking the headlights or temporarily turning on the hazard lights of the vehicle 10 (e.g., via the confirmation component 220).

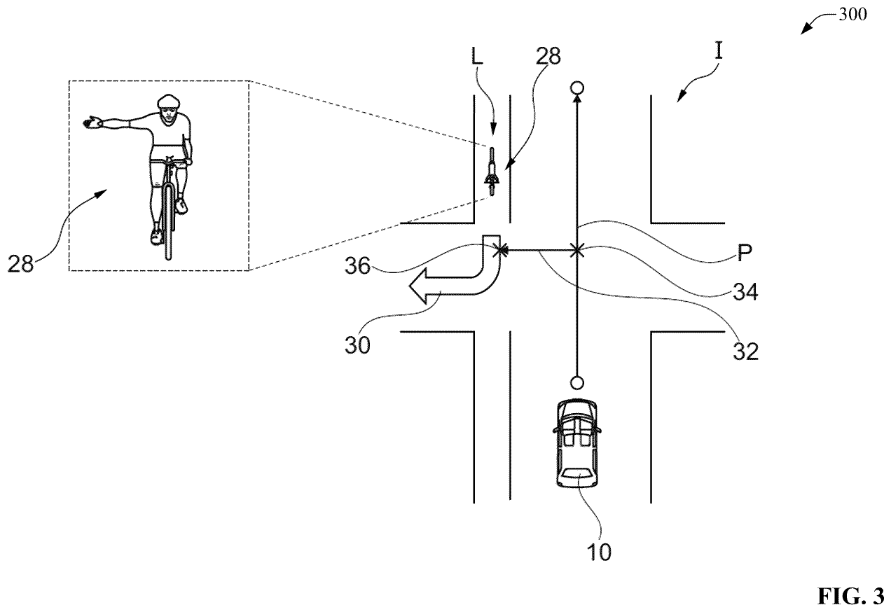

FIGS. 3-7 illustrate an example, non-limiting scenarios in accordance with various embodiments described herein. In such scenarios, the vehicle 10 can be traveling along a known vehicle path P within a traffic infrastructure I. In various embodiments herein, the vehicle path P can be determined, for instance, via the detection component 202. In some embodiments, such scenarios can comprise a series of events or steps, however, the scenarios are presented in a non-limiting sequence and/or one or more steps or scenarios can be added, duplicated, omitted, etc.

The traffic infrastructure I can comprise a network of roads and pathways which can be traveled by the vehicle 10. For illustrative purposes, only a small portion of such a network is represented in FIGS. 3-7. Furthermore, the vehicle 10 shares the traffic infrastructure I with a cyclist 28. In this regard, the same roads and pathways of the traffic infrastructure I are utilized by both the vehicle 10 and the cyclist 28.

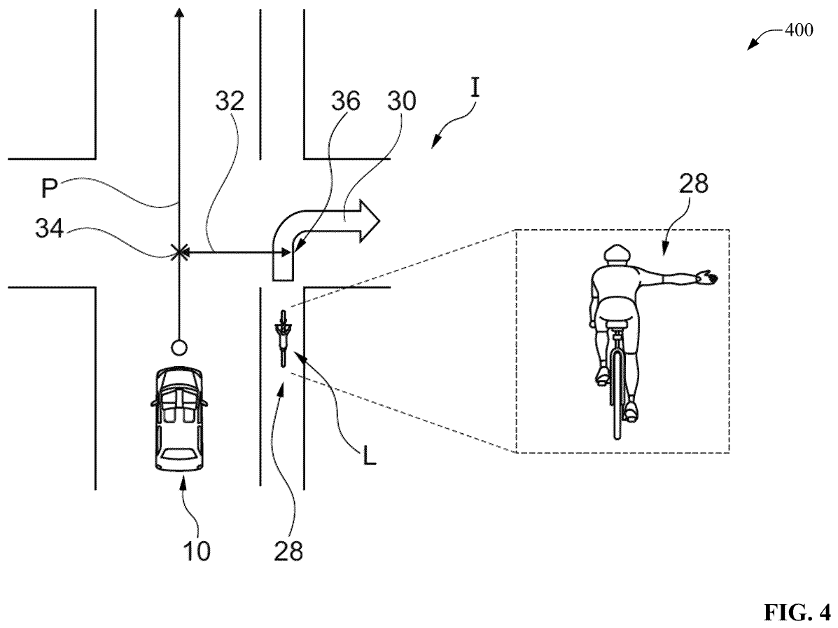

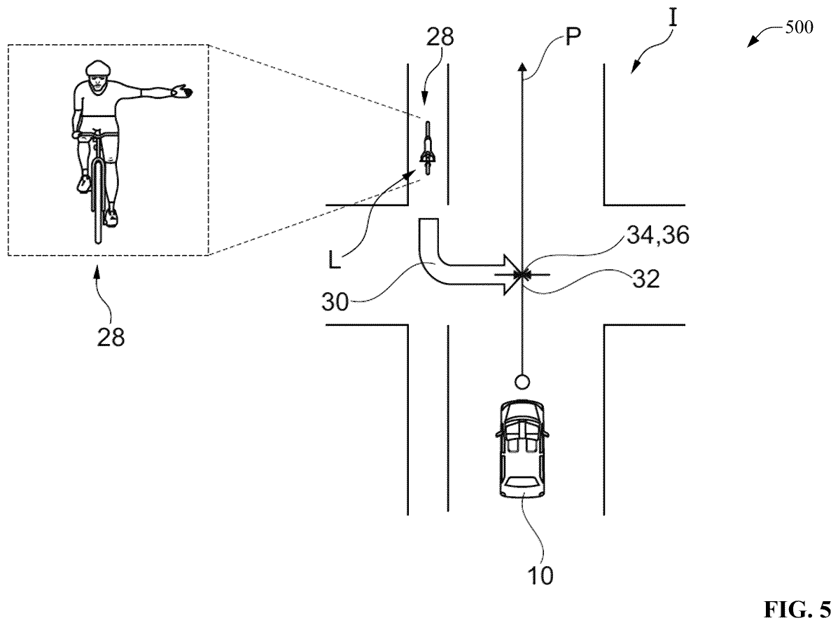

In scenario 300 of FIG. 3, the cyclist path 30 comprises a turn to the right from the perspective of the cyclist 28, since the cyclist 28 has been found to extend his or her right arm and the map information relates to a street crossing ahead of the cyclist 28. In scenario 400 of FIG. 4, the cyclist path 30 comprises a turn to the right from the perspective of the cyclist 28, since the cyclist 28 has been found to extend his or her right arm and the map information relates to a street crossing ahead of the cyclist 28. In scenario 500 of FIG. 5, the cyclist path 30 comprises a turn to the left from the perspective of the cyclist 28, since the cyclist 28 has been found to extend his or her left arm to the left and the map information relates to a street crossing ahead of the cyclist 28. It is noted that in the application scenarios of FIGS. 3 and 5, the cyclist 28 and the vehicle 10 are traveling towards each other, whereas in the application scenario of FIG. 4 the vehicle 10 and the cyclist 28 of traveling into the same direction.

In various embodiments, a minimal path distance 32 between the vehicle path P and the cyclist path 30 can be determined (e.g., via the interference component 208) and compared (e.g., via the interference component 208) to a minimal path distance threshold. In FIG. 3 and the FIG. 4, the minimal path distance 32 has been determined (e.g., via the interference component 208) to exceed the minimal path distance threshold. In these cases, a process herein can be stopped, for instance, since the vehicle path P and the cyclist path 30 do not interfere with one another.

In FIG. 5, the vehicle path P and the cyclist path 30 cross each other. Thus, the minimal path distance 32 is zero, which is inferior to the minimal path distance threshold. Since it is found that the vehicle path P and the cyclist paths 30 interfere with one another, also a location 34, 36 of interference can be determined (e.g., via the interference component 208) for each of the vehicle path P and the cyclist path 30. The locations 34, 36 of interference can comprise the locations 34, 36 of the respective vehicle path P or cyclist path 30 which limit the minimal path distance 32 between the vehicle path P and the cyclist path 30. In a case in which the vehicle path P and the cyclist path 30 cross each other, the locations 34, 36 of interference of the vehicle path P and the cyclist path 30 are identical. Thus, an interference risk can be determined (e.g., via the interference component 208). The interference risk can describe whether the vehicle 10 and the cyclist 28 risk to interfere with one another at the respective location 34, 36 of interference.

In scenarios 500 and 600, the minimal traveler offset is a time span T between the vehicle 10 travelling over the location 34 of interference of the vehicle path P and the cyclist 28 travelling over the location 36 of interference of the cyclist path 30. Consequently, the offset threshold is a minimal time span threshold.

In order to determine the time span T, the current vehicle speed can be determined via the navigation component 218. A current cyclist speed can be determined (e.g., via the detection component 202), for instance, based on the captured images, as previously discussed. Based on the captured images, a location L of the cyclist 28 can be determined (e.g., via the location component 204). In various embodiments, the cyclist speed can be derived (e.g., via the detection component 202) from a comparison of two locations L as shown in captured images and a time span lying between capturing these two images.

Moreover, using the location L of the cyclist 28 as described above, the map information received from the navigation component 218 and the location 36 of interference of the cyclist path 30, a current distance between the cyclist 28 and the location 36 of interference of the cyclist path 30 can be determined (e.g., via the detection component 202).

Similarly, using a known location of the vehicle 10 which can also be provided by the navigation component 218, the map information, and/or the location 34 of interference of the vehicle path P, a current distance between the vehicle 10 and the location 34 of interference of the vehicle path P can be determined (e.g., via the detection component 202).

Using this distance information in combination with the speed information, a current time estimate T1 describing a time needed by the vehicle 10 to reach the location 34 of interference of the vehicle path P and a current time estimate T2 describing at time needed by the cyclist 28 to reach the location 36 of interference of the cyclist path 30 can be calculated (e.g., via the estimation component 206 or another suitable component herein). The time span T can then be determined as the difference between the time estimate T1 and the time estimate T2. Thus, in various embodiments, the time span T describes a time difference between the vehicle 10 traveling over the location 34 of interference of the vehicle path P and the cyclist 28 traveling over the location 36 of interference of the cyclist path 30. From the perspective of the vehicle 10, the time span T can be designated as a time to pass for the cyclist 28. The time span T can then be compared (e.g., via the interference component 208) to the minimal time span threshold. In a nonlimiting example, the minimal time span threshold can comprise ten seconds. In this regard, if within ten seconds or fewer, the vehicle 10 travels over the location 34 of interference of the vehicle path P and the cyclist 28 travels over the location 36 of interference of the cyclist path 30, a risk of interference is determined (e.g., via the risk component 210). Otherwise, no risk of interference is determined (e.g., via the risk component 210)

In various embodiments, based on the above determined locations, a current distance between the vehicle 10 and the cyclist 28 can also be determined (e.g., via the detection component 202). This can comprise a safety measure, ensuring that the vehicle 10 and the cyclist 28 maintain a minimal safety distance.

It is noted that as an alternative to the calculation of the time span T, determination of the interference risk (e.g., via the risk component 210) can be based on the calculation of a minimal traveler offset which is a minimal geometric distance between the vehicle 10 and the cyclist 28. Thus, a minimal geometric distance between the vehicle 10 and the cyclist 28 can be determined. If the minimal geometric distance falls below a minimal geometric distance threshold, an interference risk can be determined (e.g., via the risk component 210).

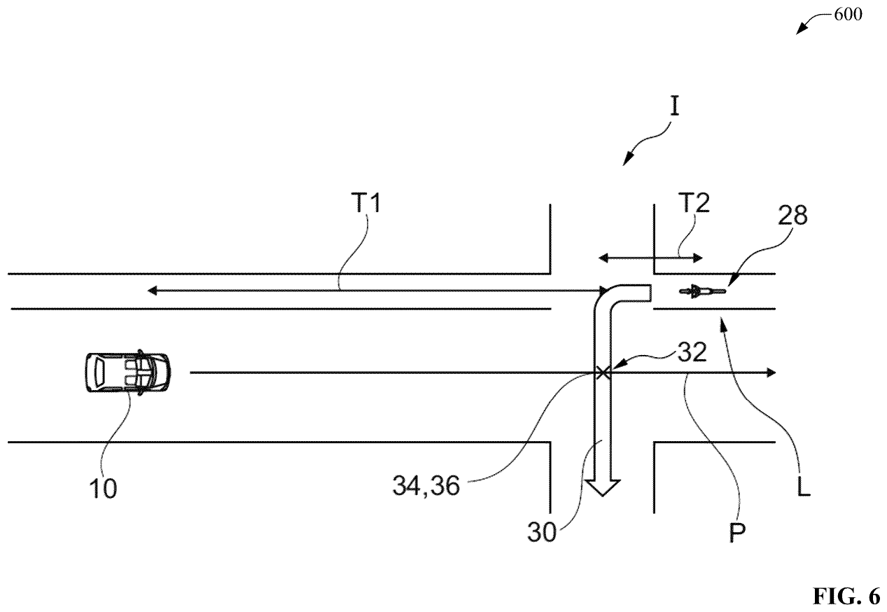

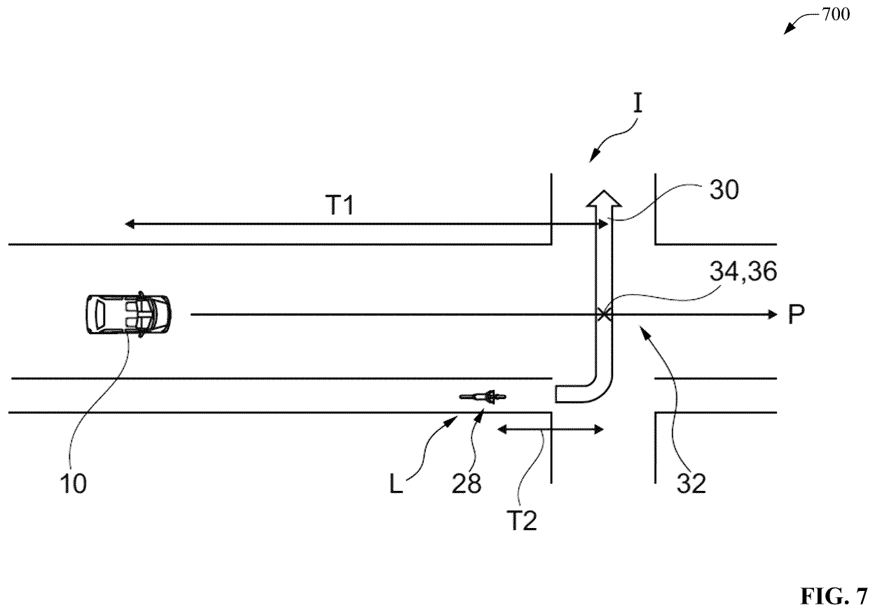

FIG. 7 illustrates a scenario 700 in which, in contrast to the application scenario of FIG. 6, the cyclist 28 and the vehicle 10 are traveling into the same direction. As before, the time span T can be determined (e.g., via the estimation component 206 or another suitable component herein) by determining the time estimates T1 and T2 as has been explained above. Consequently, controlling the vehicle 10 can be independent from the fact whether the vehicle 10 and the cyclist 28 travel towards each other or into the same direction. Based on the detected interference risk, a reaction maneuver of the vehicle 10 can be triggered (e.g., via the reaction maneuver component 212). In various embodiments, the reaction maneuver can comprise triggering a deceleration activity and/or triggering a steering activity of the vehicle 10. In some embodiments, the vehicle 10 can, for example, stop or reduce its traveling speed (e.g., via the navigation component 218). Alternatively, the vehicle 10 can change lanes (e.g., via the navigation component 218). It is noted that the reaction maneuver (e.g., via the reaction maneuver component 212) can also be dependent on a current traveling speed of the vehicle 10.

If an interference risk has been determined (e.g., via the risk component 210), also a warning activity of the vehicle 10 can be triggered (e.g., via the warning component 214). In various embodiments, warning activity can comprise honking, turning on the hazard lights, and/or another suitable warning activity that has the potential to make the cyclist 28 notice the vehicle 10. In one or more embodiments, a warning activity of increased intensity can be triggered (e.g., via the warning component 214) if it is determined (e.g., via the risk component 210) that a collision between the vehicle 10 and the cyclist 28 is inevitable. The inevitability can be determined (e.g., via the risk component 210), for instance, based on the current distance between the vehicle 10 and the cyclist 28.

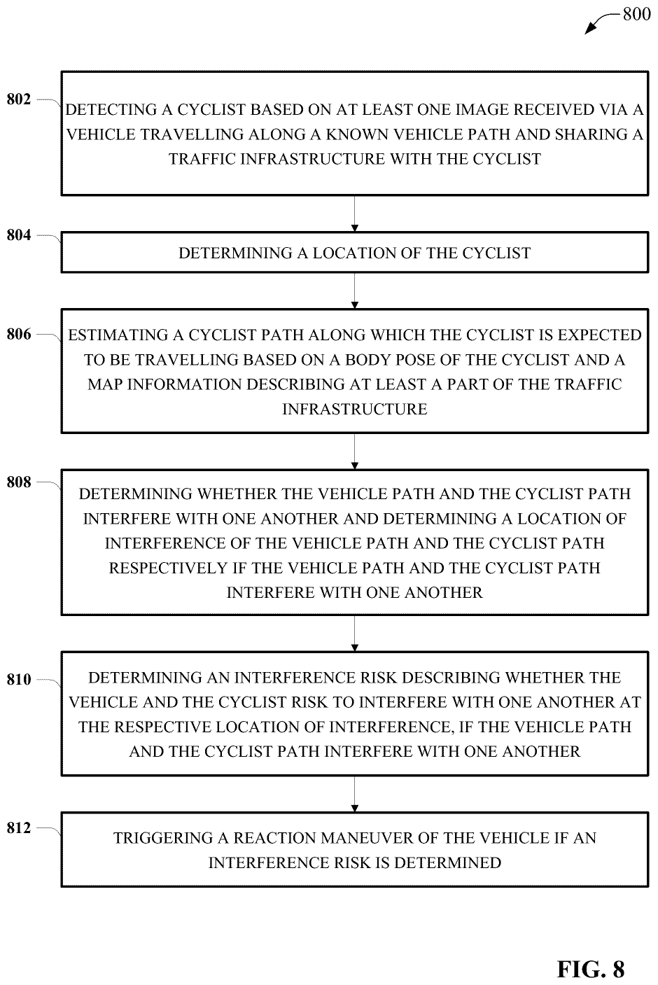

FIG. 8 illustrates a block flow diagram for a process 800 associated with vehicles or corresponding vehicle systems in accordance with one or more embodiments described herein. At 802, the process 800 can comprise detecting (e.g., via a detection component 202) a cyclist 28 based on at least one image captured or received (e.g., from an environment detection component 216 of a vehicle 10 travelling along a known vehicle path P and sharing a traffic infrastructure I with the cyclist 28). At 804, the process 800 can comprise determining (e.g., via a location component 204) a location of the cyclist 28. At 806, the process 800 can comprise estimating (e.g., via an estimation component 206) a cyclist path 30 along which the cyclist 28 is expected to be travelling based on a body pose of the cyclist and a map information describing at least a part of the traffic infrastructure I. At 808, the process 800 can comprise determining (e.g., via the interference component 208) whether the vehicle path P and the cyclist path 30 interfere with one another and determining a location of interference of the vehicle path P and the cyclist path 30 respectively if the vehicle path P and the cyclist path 30 interfere with one another. At 810, the process 800 can comprise determining (e.g., via a risk component 210) an interference risk describing whether the vehicle 10 and the cyclist 28 risk to interfere with one another at the respective location of interference, if the vehicle path P and the cyclist path 30 interfere with one another. At 812, the process 800 can comprise triggering (e.g., via the reaction maneuver component 212) a reaction maneuver of the vehicle 10 if an interference risk is determined.

Systems described herein can be coupled (e.g., communicatively, electrically, operatively, optically, inductively, acoustically, etc.) to one or more local or remote (e.g., external) systems, sources, and/or devices (e.g., electronic control systems (ECU), classical and/or quantum computing devices, communication devices, etc.). For example, system 100 (or other systems, controllers, processors, etc.) can be coupled (e.g., communicatively, electrically, operatively, optically, etc.) to one or more local or remote (e.g., external) systems, sources, and/or devices using a data cable (e.g., High-Definition Multimedia Interface (HDMI), recommended standard (RS), Ethernet cable, etc.) and/or one or more wired networks described below.

In some embodiments, systems herein can be coupled (e.g., communicatively, electrically, operatively, optically, inductively, acoustically, etc.) to one or more local or remote (e.g., external) systems, sources, and/or devices (e.g., electronic control units (ECU), classical and/or quantum computing devices, communication devices, etc.) via a network. In these embodiments, such a network can comprise one or more wired and/or wireless networks, including, but not limited to, a cellular network, a wide area network (WAN) (e.g., the Internet), and/or a local area network (LAN). For example, system 100 can communicate with one or more local or remote (e.g., external) systems, sources, and/or devices, for instance, computing devices using such a network, which can comprise virtually any desired wired or wireless technology, including but not limited to: powerline ethernet, VHF, UHF, AM, wireless fidelity (Wi-Fi), BLUETOOTH®, fiber optic communications, global system for mobile communications (GSM), universal mobile telecommunications system (UMTS), worldwide interoperability for microwave access (WiMAX), enhanced general packet radio service (enhanced GPRS), third generation partnership project (3GPP) long term evolution (LTE), third generation partnership project 2 (3GPP2) ultra-mobile broadband (UMB), high speed packet access (HSPA), Zigbee and other 802.XX wireless technologies and/or legacy telecommunication technologies, Session Initiation Protocol (SIP), ZIGBEE®, RF4CE protocol, WirelessHART protocol, L-band voice or data information, 6LoWPAN (IPv6 over Low power Wireless Area Networks), Z-Wave, an ANT, an ultra-wideband (UWB) standard protocol, and/or other proprietary and non-proprietary communication protocols. In this example, system 100 can thus include hardware (e.g., a central processing unit (CPU), a transceiver, a decoder, an antenna (e.g., a ultra-wideband (UWB) antenna, a BLUETOOTH® low energy (BLE) antenna, etc.), quantum hardware, a quantum processor, etc.), software (e.g., a set of threads, a set of processes, software in execution, quantum pulse schedule, quantum circuit, quantum gates, etc.), or a combination of hardware and software that facilitates communicating information between a system herein and remote (e.g., external) systems, sources, and/or devices (e.g., computing and/or communication devices such as, for instance, a smart phone, a smart watch, wireless earbuds, etc.).

Systems herein can comprise one or more computer and/or machine readable, writable, and/or executable components and/or instructions that, when executed by processor (e.g., a processing unit 116 which can comprise a classical processor, a quantum processor, etc.), can facilitate performance of operations defined by such component(s) and/or instruction(s). Further, in numerous embodiments, any component associated with a system herein, as described herein with or without reference to the various figures of the subject disclosure, can comprise one or more computer and/or machine readable, writable, and/or executable components and/or instructions that, when executed by a processor, can facilitate performance of operations defined by such component(s) and/or instruction(s). Consequently, according to numerous embodiments, system herein and/or any components associated therewith as disclosed herein, can employ a processor (e.g., processing unit 116) to execute such computer and/or machine readable, writable, and/or executable component(s) and/or instruction(s) to facilitate performance of one or more operations described herein with reference to system herein and/or any such components associated therewith.

Systems herein can comprise any type of system, device, machine, apparatus, component, and/or instrument that comprises a processor and/or that can communicate with one or more local or remote electronic systems and/or one or more local or remote devices via a wired and/or wireless network. All such embodiments are envisioned. For example, a system (e.g., a system 100 or any other system or device described herein) can comprise a computing device, a general-purpose computer, field-programmable gate array, AI accelerator application-specific integrated circuit, a special-purpose computer, an onboard computing device, a communication device, an onboard communication device, a server device, a quantum computing device (e.g., a quantum computer), a tablet computing device, a handheld device, a server class computing machine and/or database, a laptop computer, a notebook computer, a desktop computer, wearable device, internet of things device, a cell phone, a smart phone, a consumer appliance and/or instrumentation, an industrial and/or commercial device, a digital assistant, a multimedia Internet enabled phone, a multimedia players, and/or another type of device.

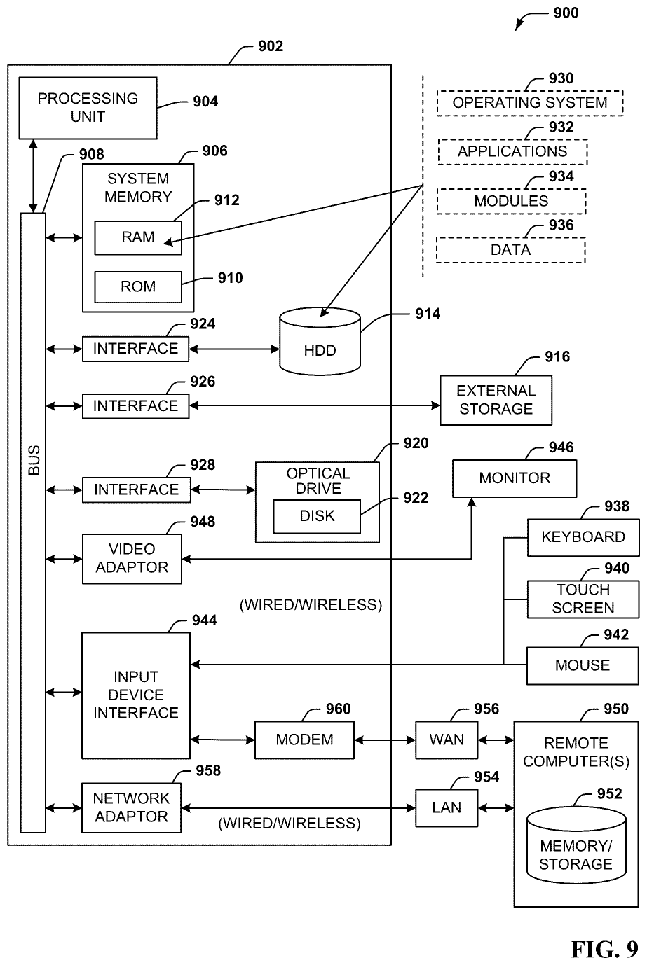

In order to provide additional context for various embodiments described herein, FIG. 9 and the following discussion are intended to provide a brief, general description of a suitable computing environment 900 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers (e.g., ruggedized personal computers), field-programmable gate arrays, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory, or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, optic, infrared, and other wireless media.

With reference again to FIG. 9, the example environment 900 for implementing various embodiments of the aspects described herein includes a computer 902, the computer 902 including a processing unit 904, a system memory 906 and a system bus 908. The system bus 908 couples system components including, but not limited to, the system memory 906 to the processing unit 904. The processing unit 904 can be any of various commercially available processors, field-programmable gate array, AI accelerator application-specific integrated circuit, or other suitable processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes ROM 910 and RAM 912. A basic input/output system (BIOS) can be stored in a non-volatile memory such as ROM, erasable programmable read only memory (EPROM), EEPROM, which BIOS contains the basic routines that help to transfer information between elements within the computer 902, such as during startup. The RAM 912 can also include a high-speed RAM such as static RAM for caching data. It is noted that unified Extensible Firmware Interface(s) can be utilized herein.

The computer 902 further includes an internal hard disk drive (HDD) 914 (e.g., EIDE, SATA), one or more external storage devices 916 (e.g., a magnetic floppy disk drive (FDD) 916, a memory stick or flash drive reader, a memory card reader, etc.) and an optical disk drive 920 (e.g., which can read or write from a disc 922 such as a CD-ROM disc, a DVD, a BD, etc.). While the internal HDD 914 is illustrated as located within the computer 902, the internal HDD 914 can also be configured for external use in a suitable chassis (not shown). Additionally, while not shown in environment 900, a solid-state drive (SSD) could be used in addition to, or in place of, an HDD 914. The HDD 914, external storage device(s) 916 and optical disk drive 920 can be connected to the system bus 908 by an HDD interface 924, an external storage interface 926 and an optical drive interface 928, respectively. The interface 924 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 902, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 912, including an operating system 930, one or more application programs 932, other program modules 934 and program data 936. All or portions of the operating system, applications, modules, and/or data can also be cached in the RAM 912. The systems and methods described herein can be implemented utilizing various commercially available operating systems or combinations of operating systems.

Computer 902 can optionally comprise emulation technologies. For example, a hypervisor (not shown) or other intermediary can emulate a hardware environment for operating system 930, and the emulated hardware can optionally be different from the hardware illustrated in FIG. 9. In such an embodiment, operating system 930 can comprise one virtual machine (VM) of multiple VMs hosted at computer 902. Furthermore, operating system 930 can provide runtime environments, such as the Java runtime environment or the .NET framework, for applications 932. Runtime environments are consistent execution environments that allow applications 932 to run on any operating system that includes the runtime environment. Similarly, operating system 930 can support containers, and applications 932 can be in the form of containers, which are lightweight, standalone, executable packages of software that include, e.g., code, runtime, system tools, system libraries and settings for an application.

Further, computer 902 can be enabled with a security module, such as a trusted processing module (TPM). For instance, with a TPM, boot components hash next in time boot components, and wait for a match of results to secured values, before loading a next boot component. This process can take place at any layer in the code execution stack of computer 902, e.g., applied at the application execution level or at the operating system (OS) kernel level, thereby enabling security at any level of code execution.

A user can enter commands and information into the computer 902 through one or more wired/wireless input devices, e.g., a keyboard 938, a touch screen 940, and a pointing device, such as a mouse 942. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 904 through an input device interface 944 that can be coupled to the system bus 908, but can be connected by other interfaces, such as a parallel port, an IEEE 1394 serial port, a game port, a USB port, an IR interface, a BLUETOOTH® interface, etc.

A monitor 946 or other type of display device can be also connected to the system bus 908 via an interface, such as a video adapter 948. In addition to the monitor 946, a computer typically includes other peripheral output devices (not shown), such as speakers, printers, etc.

The computer 902 can operate in a networked environment using logical connections via wired and/or wireless communications to one or more remote computers, such as a remote computer(s) 950. The remote computer(s) 950 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 952 is illustrated. The logical connections depicted include wired/wireless connectivity to a local area network (LAN) 954 and/or larger networks, e.g., a wide area network (WAN) 956. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 can be connected to the local network 954 through a wired and/or wireless communication network interface or adapter 958. The adapter 958 can facilitate wired or wireless communication to the LAN 954, which can also include a wireless access point (AP) disposed thereon for communicating with the adapter 958 in a wireless mode.

When used in a WAN networking environment, the computer 902 can include a modem 960 or can be connected to a communications server on the WAN 956 via other means for establishing communications over the WAN 956, such as by way of the Internet. The modem 960, which can be internal or external and a wired or wireless device, can be connected to the system bus 908 via the input device interface 944. In a networked environment, program modules depicted relative to the computer 902 or portions thereof, can be stored in the remote memory/storage device 952. It will be appreciated that the network connections shown are example and other means of establishing a communications link between the computers can be used.

When used in either a LAN or WAN networking environment, the computer 902 can access cloud storage systems or other network-based storage systems in addition to, or in place of, external storage devices 916 as described above. Generally, a connection between the computer 902 and a cloud storage system can be established over a LAN 954 or WAN 956 e.g., by the adapter 958 or modem 960, respectively. Upon connecting the computer 902 to an associated cloud storage system, the external storage interface 926 can, with the aid of the adapter 958 and/or modem 960, manage storage provided by the cloud storage system as it would other types of external storage. For instance, the external storage interface 926 can be configured to provide access to cloud storage sources as if those sources were physically connected to the computer 902.

The computer 902 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

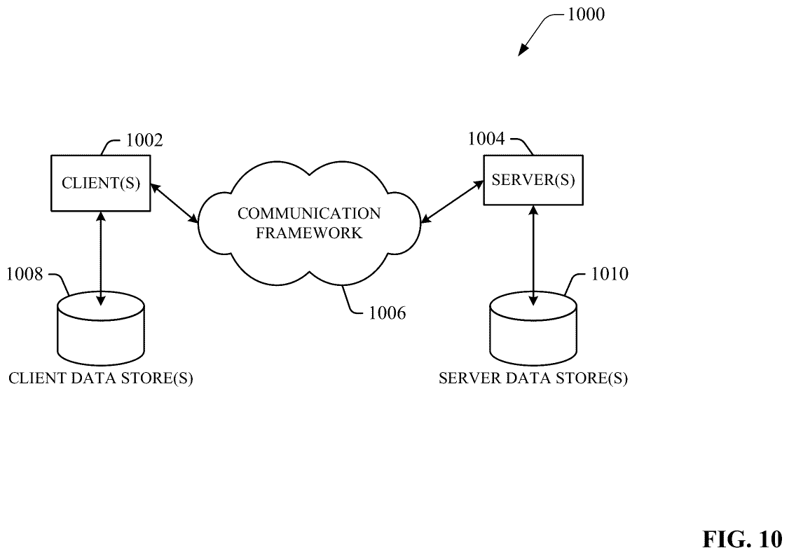

Referring now to FIG. 10, there is illustrated a schematic block diagram of a computing environment 1000 in accordance with this specification. The system 1000 includes one or more client(s) 1002, (e.g., computers, smart phones, tablets, cameras, PDA's). The client(s) 1002 can be hardware and/or software (e.g., threads, processes, computing devices). The client(s) 1002 can house cookie(s) and/or associated contextual information by employing the specification, for example.

The system 1000 also includes one or more server(s) 1004. The server(s) 1004 can also be hardware or hardware in combination with software (e.g., threads, processes, computing devices). The servers 1004 can house threads to perform transformations of media items by employing aspects of this disclosure, for example. One possible communication between a client 1002 and a server 1004 can be in the form of a data packet adapted to be transmitted between two or more computer processes wherein data packets may include coded analyzed headspaces and/or input. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004. Further, the client(s) 1002 can be operatively connected to one or more server data store(s) 1010.

In one exemplary implementation, a client 1002 can transfer an encoded file, (e.g., encoded media item), to server 1004. Server 1004 can store the file, decode the file, or transmit the file to another client 1002. It is noted that a client 1002 can also transfer uncompressed file to a server 1004 and server 1004 can compress the file and/or transform the file in accordance with this disclosure. Likewise, server 1004 can encode information and transmit the information via communication framework 1006 to one or more clients 1002.

The illustrated aspects of the disclosure can also be practiced in distributed computing environments where certain tasks are performed by remote processing devices that are linked through a communications network. In a distributed computing environment, program modules can be located in both local and remote memory storage devices.

The above description includes non-limiting examples of the various embodiments. It is, of course, not possible to describe every conceivable combination of components or methods for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above-described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature can be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

Further aspects of the invention are provided by the subject matter of the following clauses:

1. A method for controlling a vehicle, wherein the vehicle is travelling along a known vehicle path and shares a traffic infrastructure with a cyclist, the method comprising:
detecting, by a system comprising a processor, the cyclist based on at least one image received via the vehicle;
determining, by the system, a location of the cyclist;
estimating, by the system, a cyclist path along which the cyclist is expected to be travelling based on a body pose of the cyclist and a map information describing at least a part of the traffic infrastructure;
determining, by the system, whether the vehicle path and the cyclist path interfere with one another and determining a location of interference of the vehicle path and the cyclist path respectively if the vehicle path and the cyclist path interfere with one another;
determining, by the system, an interference risk describing whether the vehicle and the cyclist risk to interfere with one another at the respective location of interference, if the vehicle path and the cyclist path interfere with one another; and
triggering, by the system, a reaction maneuver of the vehicle if an interference risk is determined.

2. The method of any preceding clause, wherein determining whether the vehicle path and the cyclist path interfere with one another comprises determining a minimal path distance between the vehicle path and the cyclist path and comparing the minimal path distance to a minimal path distance threshold.

3. The method of any preceding clause, wherein determining the interference risk comprises determining a minimal traveler offset between the vehicle and the cyclist occurring while the vehicle is travelling along the vehicle path and the cyclist is travelling along the cyclist path, and comparing the minimal traveler offset to an offset threshold.

4. The method of any preceding clause, wherein the minimal traveler offset is a minimal geometric distance between the vehicle and the cyclist and the offset threshold is a minimal traveler distance threshold.

5. The method of any preceding clause, wherein the minimal traveler offset is a time span between the vehicle travelling over the location of interference of the vehicle path and the cyclist travelling over the location of interference of the cyclist path and the offset threshold is a minimal time span threshold.

6. The method of any preceding clause, wherein determining an interference risk comprises determining or receiving an information describing at least one of:
a current cyclist speed,
a current vehicle speed,
a current distance between the vehicle and the cyclist,
a current distance between the vehicle and the location of interference of the vehicle path,
a current distance between the cyclist and the location of interference of the cyclist path,
a current time estimate describing a time needed by the vehicle to reach the location of interference of the vehicle path, or
a current time estimate describing at time needed by the cyclist to reach the location of interference of the cyclist path.

7. The method of any preceding clause, wherein estimating the cyclist path comprises receiving the map information from a navigation system.

8. The method of any preceding clause, wherein estimating the cyclist path comprises detecting the body pose of the cyclist.

9. The method of any preceding clause, wherein the body pose is an arm pose of the cyclist.

10. The method of any preceding clause, wherein triggering the reaction maneuver comprises at least one of
triggering a decelerating activity, or
triggering a steering activity.

11. The method of any preceding clause, further comprising:

triggering, by the system, a warning activity of the vehicle.

12. The method of clause 1 above with any set of combinations of the methods 2-11 above.

13. A non-transitory machine-readable medium, comprising executable instructions that, when executed by a processor, facilitate performance of operations, comprising:
detecting a cyclist based on at least one image captured via a vehicle travelling along a known vehicle path and sharing a traffic infrastructure with the cyclist;
determining a location of the cyclist;
estimating a cyclist path along which the cyclist is expected to be travelling based on a body pose of the cyclist and a map information describing at least a part of the traffic infrastructure;
determining whether the vehicle path and the cyclist path interfere with one another and determining a location of interference of the vehicle path and the cyclist path respectively if the vehicle path and the cyclist path interfere with one another;
determining an interference risk describing whether the vehicle and the cyclist risk to interfere with one another at the respective location of interference, if the vehicle path and the cyclist path interfere with one another; and
triggering a reaction maneuver of the vehicle if an interference risk is determined.

14. The non-transitory machine-readable medium of any preceding clause, wherein determining whether the vehicle path and the cyclist path interfere with one another comprises determining a minimal path distance between the vehicle path and the cyclist path and comparing the minimal path distance to a minimal path distance threshold.

15. The non-transitory machine-readable medium of any preceding clause, wherein determining an interference risk comprises determining a minimal traveler offset between the vehicle and the cyclist occurring while the vehicle is travelling along the vehicle path and the cyclist is travelling along the cyclist path, and comparing the minimal traveler offset to an offset threshold.

16. The non-transitory machine-readable medium of any preceding clause, wherein the minimal traveler offset is a minimal geometric distance between the vehicle and the cyclist and the offset threshold is a minimal traveler distance threshold.

17. The non-transitory machine-readable medium of any preceding clause, wherein the minimal traveler offset is a time span between the vehicle travelling over the location of interference of the vehicle path and the cyclist travelling over the location of interference of the cyclist path and the offset threshold is a minimal time span threshold.

18. The non-transitory machine-readable medium of any preceding clause, wherein determining an interference risk comprises determining or receiving an information describing at least one of:
a current cyclist speed,
a current vehicle speed,
a current distance between the vehicle and the cyclist,
a current distance between the vehicle and the location of interference of the vehicle path,
a current distance between the cyclist and the location of interference of the cyclist path,
a current time estimate describing a time needed by the vehicle to reach the location of interference of the vehicle path, or
a current time estimate describing at time needed by the cyclist to reach the location of interference of the cyclist path.

19. The non-transitory machine-readable medium of any preceding clause, wherein estimating the cyclist path comprises receiving the map information from a navigation system.

20. The non-transitory machine-readable medium of clause 13 above with any set of combinations of the non-transitory machine-readable mediums 14-19 above.

21. A system, comprising:
a memory that stores computer executable components; and
a processor that executes the computer executable components stored in the memory, wherein the computer executable components comprise:
a detection component that detects a cyclist based on at least one image received from an environment detection component of a vehicle travelling along a known vehicle path and sharing a traffic infrastructure with the cyclist;
a location component that determines a location of the cyclist;
an estimation component that estimates a cyclist path along which the cyclist is expected to be travelling based on a body pose of the cyclist and a map information describing at least a part of the traffic infrastructure;
an interference component that determines whether the vehicle path and the cyclist path interfere with one another and determining a location of interference of the vehicle path and the cyclist path respectively if the vehicle path and the cyclist path interfere with one another;
a risk component that determines an interference risk describing whether the vehicle and the cyclist risk to interfere with one another at the respective location of interference, if the vehicle path and the cyclist path interfere with one another; and
a reaction maneuver component that triggers a reaction maneuver of the vehicle if an interference risk is determined.

22. The system of any preceding clause, wherein the computer executable components comprise:
a warning component that triggers a warning activity of the vehicle.

What is claimed is:

1. A method for controlling a vehicle, wherein the vehicle is travelling along a known vehicle path and shares a traffic infrastructure with a cyclist, the method comprising:
detecting, by a system comprising a processor, the cyclist based on at least one image received via the vehicle;
determining, by the system, a location of the cyclist;
estimating, by the system, a cyclist path along which the cyclist is expected to be travelling based on a body pose of the cyclist and a map information describing at least a part of the traffic infrastructure;
determining, by the system, whether the vehicle path and the cyclist path interfere with one another and determining a location of interference of the vehicle path and the cyclist path respectively if the vehicle path and the cyclist path interfere with one another;
determining, by the system, an interference risk describing whether the vehicle and the cyclist risk to interfere with one another at the respective location of interference, if the vehicle path and the cyclist path interfere with one another; and
triggering, by the system, a reaction maneuver of the vehicle if an interference risk is determined.

2. The method of claim 1, wherein determining whether the vehicle path and the cyclist path interfere with one another comprises determining a minimal path distance between the vehicle path and the cyclist path and comparing the minimal path distance to a minimal path distance threshold.

3. The method of claim 1, wherein determining the interference risk comprises determining a minimal traveler offset between the vehicle and the cyclist occurring while the vehicle is travelling along the vehicle path and the cyclist is travelling along the cyclist path, and comparing the minimal traveler offset to an offset threshold.

4. The method of claim 3, wherein the minimal traveler offset is a minimal geometric distance between the vehicle and the cyclist and the offset threshold is a minimal traveler distance threshold.

5. The method of claim 3, wherein the minimal traveler offset is a time span between the vehicle travelling over the location of interference of the vehicle path and the cyclist travelling over the location of interference of the cyclist path and the offset threshold is a minimal time span threshold.

6. The method of claim 1, wherein determining an interference risk comprises determining or receiving an information describing at least one of:
a current cyclist speed,
a current vehicle speed,
a current distance between the vehicle and the cyclist,
a current distance between the vehicle and the location of interference of the vehicle path,
a current distance between the cyclist and the location of interference of the cyclist path,
a current time estimate describing a time needed by the vehicle to reach the location of interference of the vehicle path, or
a current time estimate describing at time needed by the cyclist to reach the location of interference of the cyclist path.

7. The method of claim 1, wherein estimating the cyclist path comprises receiving the map information from a navigation system.

8. The method of claim 1, wherein estimating the cyclist path comprises detecting the body pose of the cyclist.

9. The method of claim 8, wherein the body pose is an arm pose of the cyclist.

10. The method of claim 1, wherein triggering the reaction maneuver comprises at least one of
triggering a decelerating activity, or
triggering a steering activity.

11. The method of claim 1, further comprising:
triggering, by the system, a warning activity of the vehicle.

12. A non-transitory machine-readable medium, comprising executable instructions that, when executed by a processor, facilitate performance of operations, comprising:
detecting a cyclist based on at least one image captured via a vehicle travelling along a known vehicle path and sharing a traffic infrastructure with the cyclist;
determining a location of the cyclist;
estimating a cyclist path along which the cyclist is expected to be travelling based on a body pose of the cyclist and a map information describing at least a part of the traffic infrastructure;
determining whether the vehicle path and the cyclist path interfere with one another and determining a location of interference of the vehicle path and the cyclist path respectively if the vehicle path and the cyclist path interfere with one another;
determining an interference risk describing whether the vehicle and the cyclist risk to interfere with one another at the respective location of interference, if the vehicle path and the cyclist path interfere with one another; and
triggering a reaction maneuver of the vehicle if an interference risk is determined.

13. The non-transitory machine-readable medium of claim 12, wherein determining whether the vehicle path and the cyclist path interfere with one another comprises determining a minimal path distance between the vehicle path and the cyclist path and comparing the minimal path distance to a minimal path distance threshold.

14. The non-transitory machine-readable medium of claim 12, wherein determining an interference risk comprises determining a minimal traveler offset between the vehicle and the cyclist occurring while the vehicle is travelling along the vehicle path and the cyclist is travelling along the cyclist path, and comparing the minimal traveler offset to an offset threshold.

15. The non-transitory machine-readable medium of claim 14, wherein the minimal traveler offset is a minimal geometric distance between the vehicle and the cyclist and the offset threshold is a minimal traveler distance threshold.

16. The non-transitory machine-readable medium of claim 14, wherein the minimal traveler offset is a time span between the vehicle travelling over the location of interference of the vehicle path and the cyclist travelling over the location of interference of the cyclist path and the offset threshold is a minimal time span threshold.

17. The non-transitory machine-readable medium of claim 12, wherein determining an interference risk comprises determining or receiving an information describing at least one of:
a current cyclist speed,
a current vehicle speed,
a current distance between the vehicle and the cyclist,
a current distance between the vehicle and the location of interference of the vehicle path,
a current distance between the cyclist and the location of interference of the cyclist path,
a current time estimate describing a time needed by the vehicle to reach the location of interference of the vehicle path, or
a current time estimate describing at time needed by the cyclist to reach the location of interference of the cyclist path.

18. The non-transitory machine-readable medium of claim 12, wherein estimating the cyclist path comprises receiving the map information from a navigation system.

19. A system, comprising:
a memory that stores computer executable components; and
a processor that executes the computer executable components stored in the memory, wherein the computer executable components comprise:
a detection component that detects a cyclist based on at least one image received from an environment detection component of a vehicle travelling along a known vehicle path and sharing a traffic infrastructure with the cyclist;
a location component that determines a location of the cyclist;
an estimation component that estimates a cyclist path along which the cyclist is expected to be travelling based on a body pose of the cyclist and a map information describing at least a part of the traffic infrastructure;
an interference component that determines whether the vehicle path and the cyclist path interfere with one another and determining a location of interference of the vehicle path and the cyclist path respectively if the vehicle path and the cyclist path interfere with one another;
a risk component that determines an interference risk describing whether the vehicle and the cyclist risk to interfere with one another at the respective location of interference, if the vehicle path and the cyclist path interfere with one another; and
a reaction maneuver component that triggers a reaction maneuver of the vehicle if an interference risk is determined.

20. The system of claim 19, wherein the computer executable components comprise:
a warning component that triggers a warning activity of the vehicle.
